(19) United States
(12) Patent Application Publication
(10) Pub. No.: US 2011/0112693 A1
(43) Pub. Date: May 12, 2011

(54) Water cooling system of building structure for air conditioning system

(76) Inventors: Jim Jiaming Ye, Arcadia, CA (US); Adam XiaoNang Wang, Arcadia, CA (US)

(21) Appl. No.: 12/930,691

(22) Filed: Jan. 12, 2011

Related U.S. Application Data
(63) Continuation-in-part of application No. 12/583,962, filed on Aug. 27, 2009.

(51) Int. Cl. G05D 23/00

(52) U.S. Cl. 700/277

(57) ABSTRACT

A water cooling control for a building structure includes a temperature sensor device and a zone controller. The temperature sensor is adapted for detecting a temperature difference of the water at each of the end loop terminals of the duct system for determining the amount of heat removed from the respective heat exchanger in responsive to heat exchange of the water. The zone controller is operatively linking with the temperature sensor device for adjustably regulating a flow rate of the water through a control valve of the delivering device in responsive to said temperature difference at each thermal zone until the water is maintained at the optimum flow rate to ensure the respective heat exchanger being operated at an optimum condition while being energy efficient.

### CROSS REFERENCE OF RELATED APPLICATION

This is a Continuation-In-Part application of a non-provisional application having an application Ser. No. 12/583,962 and a filing date of Aug. 27, 2009.

### BACKGROUND OF THE PRESENT INVENTION

1. Field of Invention

The present invention relates to a climate control system, and more particularly to a water cooling system of a building structure for an air conditioning system, which reduces climate control system energy use while providing a thermal comfort at every thermal zone without worsening the ambient condition in the surrounding area.

2. Description of Related Arts

Climate control system is particularly designed for a large building, such as office structure, hotel, hospital, apartment, skyscrapers or shopping mall, where an indoor ambient temperature thereof must be regulated. In order to maximize comfort and energy efficiency, the climate control system is able to regulate the indoor ambient temperatures of different thermal zones in the building so as to provide a thermal comfort at each of the thermal zones.

The conventional climate control system generally comprises a thermal station, such as a chiller unit and/or a heat pump, for supplying a medium at a predetermined temperature, a duct system circulating the medium to each of the thermal zones by means of a circulating pump device, heat exchangers located at each of the thermal zones to heat-exchange the medium with the air at the respective thermal zone until the ambient temperature of the thermal zone reaches the desired temperature preset by the user.

Accordingly, water is generally used as a medium to be circulated within the duct system for heat exchanging with the air in the thermal zones. In other words, a circulating pump (or group) pumps the water from the thermal station to each of the thermal zones and return back to the thermal station in a circulating manner. For example, when the user wants to cool down the designated thermal zone from an indoor ambient temperature to a desired temperature, the chilled water is pumped to the designated thermal zone through the duct system and the fan unit will generate the air flow to heat exchange the chilled water with the air within the designated thermal zone.

Conventional climate control system is able to provide thermal comfort by regulating the medium flow through control valve in response to the relationship between zone ambient temperature and the desired temperature. Generally speaking, there are two conventional configurations for the control unit. The first configuration of the control unit is an on-and-off type control unit. In this configuration, the control valve remains fully open when the indoor ambient temperature has not reached the desired temperature and is closed when the indoor ambient temperature reaches the desired temperature. The second configuration of the control unit is a flow rate regulating type control unit, which regulates the flow rate through control valve in response to a preset logic relationship between the indoor ambient temperature and the desired temperature.

However, the conventional climate control system has several drawbacks. One is that the system is not able to sufficiently and adequately deliver the right amount of thermal medium flow to the thermal zones in such manner that some thermal zones may receive more medium flow than it is required while others might not get enough medium flow in some situation. The other drawback is that the heat exchange efficiency occurring at the thermal zone is low because the delivery of the medium to various thermal zones is imbalanced, resulting that the system is running inefficiently but the energy consumption is relatively high.

In addition, the efficiency of the conventional single unit air conditioner is limited by the fact that the heat from the air conditioner is untreated and is allowed to be released into the area adjacent to and outside the building such that the ambient temperature in the area adjacent to and outside the building will be increased dramatically and adversely affected the temperature of the thermal zone. Thus, more energy is required to lower the temperature in the thermal zone for the increase caused by the heat exhausted from the conventional air conditioner.

The effect of the increase in temperature in the area adjacent to and outside the building may be more significant in those building of poor heat insulation. The rate of heat exchange between the thermal zone and the area adjacent to and outside the building is increased due to higher temperature difference and the higher energy level such that the rate of temperature increase of the thermal zone will then be increased. Therefore, more energy consumption is required just to compensate the temperature increase caused by the heat from the conventional climate control system itself.

There are further problems arising from the heat in the area adjacent to and outside the building. First, the landscape design, which are more and more important in nowadays building structure in affecting the value of the building structure may be limited and restricted by the need of good air ventilation condition for direct heat exhaust. Second, a portion of each air-conditioning system has to be protruded outside the building structure and therefore may become the eyesore of the building structure and adversely affected its appearance and hence value. Third, the heat exhaust has a direct and immediate effect to the area adjacent to and outside the building structure, making the area not suitable for any use. For example, it is undesirable to make use of the area as a recreational area such as a park, a resting area or a community area. Forth, the direct heat exhaust which heat up the area will worsen the environmental condition and may impose health problem to people around the area.

### SUMMARY OF THE PRESENT INVENTION

An object of the present invention is to provide a water cooling system of a building structure for an air conditioning system, which will reduce the amount of heat exhausted into the area adjacent to and immediately outside the thermal zones, while providing a thermal comfort at each of the thermal zones.

Another object of the present invention is to provide a water cooling system of a building structure for an air conditioning system, which prevent direct and major immediate heat exhaust into the environment causing environmental problems and adversely affecting the efficiency of the climate control system, while providing a thermal comfort at each of the thermal zones.

Another object of the present invention is to provide a water cooling system of a building structure for an air conditioning system, which provides a duct system and a delivering system diverting the heat flow throughout the climate control system so as to improve the efficiency and eliminate the environmental problems arising from the direct and immediate heat exhaust of the air conditioning system.

Another object of the present invention is to provide a water cooling system of a building structure for an air conditioning system, which provides a duct system comprising a temperature sensor device such that the energy consumption of each thermal zone in the climate control system can be detected, thus enabling the calculation and management of the energy consumption by each air conditioning system.

Another object of the present invention is also to provide an energy saving control system and method for climate control system for saving energy while providing a thermal comfort at each of the thermal zones.

Another object of the present invention is to provide an energy saving control system and method for climate control system, which ensures the heat exchange occurs at each of the end loop terminals of a duct system by selectively adjusting a flow rate of a medium towards the end loop terminal so as to provide a thermal comfort at each thermal zone while being energy efficient.

Another object of the present invention is to provide an energy saving control system and method for climate control system, which ensures the pressure difference between both ends of the heat exchanger located in the most adverse end loop terminal to remain constant by selectively adjusting the speed of the delivering device so as to reduce the energy use of the delivering device while providing thermal comfort at each thermal zone.

Another object of the present invention is to provide an energy saving control system and method for climate control system, which sends command to the thermal station control system to regulate the outlet water temperature of the thermal station in response to the degree of opening of control valves to ensure that: (i) in cooling mode, the climate control system can meet the thermal comfort need at the thermal zones with medium with the highest possible temperature; (ii) in heating mode, the climate control system can meet the thermal comfort need at the thermal zones with medium with the lowest possible temperature so as to reduce the energy use of the thermal station.

Another object of the present invention is to provide an energy saving control system and method for climate control system, which can also control the fan unit to selectively adjust the air flow rate of the fan unit in response to the difference between zone ambient temperature and desired zone ambient temperature Tᵤₛₑᵣ.

Another object of the present invention is to provide an energy saving control system and method for climate control system, no expensive or complicated structure is required to employ in the present invention in order to achieve the above mentioned objects. Therefore, the present invention successfully provides an economic and efficient solution for providing a thermal comfort at each of the thermal zones and for saving energy to operate the climate control system.

The above and other objects of the present invention can be achieved by providing the climate control system controller with control logic, which continually polls:

(1) the degree of opening of all control valves from zone controller associated with a series of heat exchangers downstream of the thermal station; and/or

(2) the pressure difference between both ends of the heat exchanger located in each of the potential most adverse end loop terminals so as to determine which potential most adverse end loop terminal is the most adverse end loop terminal wherein its pressure difference is the smallest among the pressure differences of all of the potential most adverse end loop terminals at each moment;

If the pressure difference detected in every moment between both ends of the heat exchanger located in the most adverse end loop terminal is increased, the system controller will regulate the speed of the delivering device through the frequency converter to decrease the pressure difference until the pressure difference reaches the predetermined value which is the nominal pressure difference.

If the pressure difference detected in every moment between both ends of the heat exchanger located in the most adverse end loop terminal is decreased, the system controller will regulate the speed of the delivering device through the frequency converter to increase the pressure difference until the pressure difference reaches the predetermined value which is the nominal pressure difference.

If the greatest degree of opening of selected control valves is sensed to be smaller than a preset value of very close to 100%, the system controller is operative to send command to the thermal station control system to:

(1) in cooling mode, increase the outlet water temperature of the thermal station until the degree of opening of selected control valves reaches the preset value;

(2) in heating mode, decrease the outlet water temperature of the thermal station until the degree of opening of selected control valves reaches the preset value.

The above and other objects are also achieved by providing climate control system zone controller at each thermal zone with control logic, which is operative to configure the degree of opening of the valve to regulate the water flow in response to the inlet and outlet water temperature difference of the heat exchanger in its respective thermal zone to maintain water at the optimum flow rate to provide a thermal comfort at the thermal zone while being energy efficient.

The present invention provides an energy saving system for a climate control system which comprises one or more thermal stations, a duct system for heat exchange medium to be circulated to each end loop terminal at each thermal zone, at least a delivering device for delivering the medium to circulating in the duct system, a heat exchanger located at each of the thermal zones for heat-exchanging the medium with the air at the respective thermal zone.

The energy saving system comprises a temperature sensor device and a zone controller at each thermal zone.

The temperature sensor device is arranged for detecting a temperature difference of the medium at each of the end loop terminals of the duct system for ensuring heat exchange process occurring at optimal level, that is at ΔT>ΔTₙ, at each of the thermal zones, wherein ΔTₙ is nominal temperature difference between the supply thermal medium and the return thermal medium.

The zone controller is operatively linking with the temperature sensor device and the flow control valve for adjustably regulating a flow rate of the medium through the control valve in response to the temperature difference at each thermal zone until the medium is maintained at the optimum flow rate to reach a desired temperature of the respective thermal zone so as to provide a thermal comfort at the thermal zone while being energy efficient.

The energy saving system may further comprises one or more pressure sensor devices each of which is arranged for detecting the pressure difference between both ends of the heat exchanger located in each potential most adverse end loop terminal downstream of the thermal station, wherein by polling the detected pressure differences of the potential most adverse end loop terminals, the pressure difference in every moment between both ends of the heat exchanger in the most adverse end loop terminal downstream of the thermal station can be determined and be maintained to a preset value, that is ΔP=ΔPₙ, wherein ΔPₙ is nominal pressure difference.

In which, the system controller is operatively linking with the pressure sensor devices located in the potential most adverse end loop terminals for adjustably regulating the speed of delivering device in response to the pressure difference between both ends of the heat exchanger located in the most adverse end loop terminal until the pressure difference is maintained at the preset value ΔPₙ from time to time so as to provide a thermal comfort at the thermal zone while being energy efficient.

Accordingly, the present invention also provides an energy saving method for the climate control system, which comprises the steps of:

(a) detecting the temperature difference of the medium at each end loop terminal of the duct system for ensuring heat exchange process occurring at each of the thermal zones; and

(b) adjustably regulating the flow rate of the medium through the valve device in response to the temperature difference at each thermal zone until the medium is maintained at the optimum flow rate to reach a desired temperature of the respective thermal zone so as to provide a thermal comfort at the thermal zone while being energy efficient.

The method may further comprise the following step:

(c) detecting the pressure difference between both ends of each of the heat exchangers located in each potential most adverse end loop terminals for ensuring adequate pressure for the duct system.

The method may further comprise the following step:

(d) detecting the degree of opening of all control valves for ensuring heat station consume the least possible energy to condition (cool or heat) thermal medium while providing thermal comfort at each thermal zone.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a climate control system incorporating with an energy saving system according to a first preferred embodiment of the present invention.

FIG. 2 is a schematic view of the temperature sensor device incorporating with the heat exchanger of the climate control system according to the first preferred embodiment of the present invention.

FIG. 3 is a graph illustrating the flow rate of the medium being regulated in different stages according to the first preferred embodiment of the present invention.

FIG. 4 is a flow diagram illustrating the temperature difference control of the energy saving method according to the first preferred embodiment of the present invention.

FIG. 5 is a schematic view of the climate control system incorporating with an energy saving system according to the first preferred embodiment of the present invention.

FIG. 6 is a flow diagram illustrating the pressure difference control of the energy saving system according to the first preferred embodiment of the present invention.

FIG. 7 is a schematic view illustrating the heat exchanging loops extended in the duct system according to the first preferred embodiment of the present invention.

FIG. 8 is a schematic view of a water cooling system of a building structure for incorporating with air conditioning system according to a second preferred embodiment of the present invention.

FIG. 9 is a block diagram of a water cooling system according to the second preferred embodiment of the present invention.

FIG. 10 is a schematic view of the temperature sensor device incorporating with the heat exchanger of the water cooling system according to the second preferred embodiment of the present invention.

FIG. 11 is a schematic view of the climate control system incorporating with an energy saving system according to the second preferred embodiment of the present invention.

FIG. 12 is a schematic view illustrating the heat exchanging loops extended in the duct system according to the second preferred embodiment of the present invention.

FIG. 13 is a flow diagram illustrating the energy saving method of the energy saving system according to the second preferred embodiment of the present invention.

### DETAILED DESCRIPTION OF THE PREFERRED EMBODIMENT

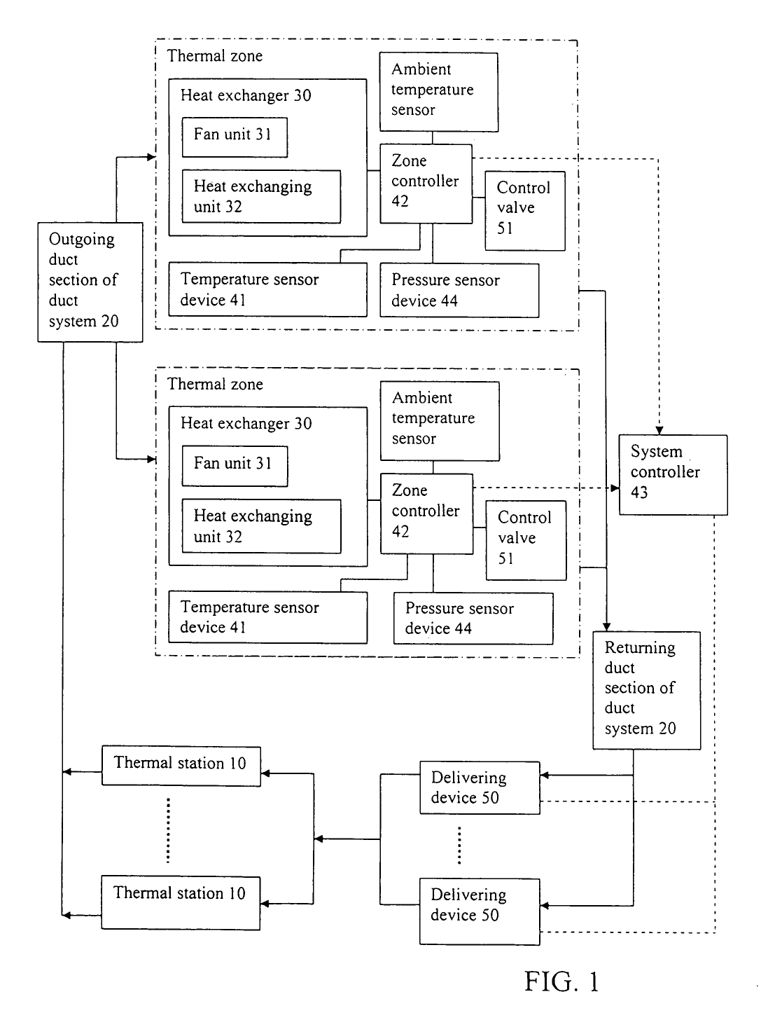

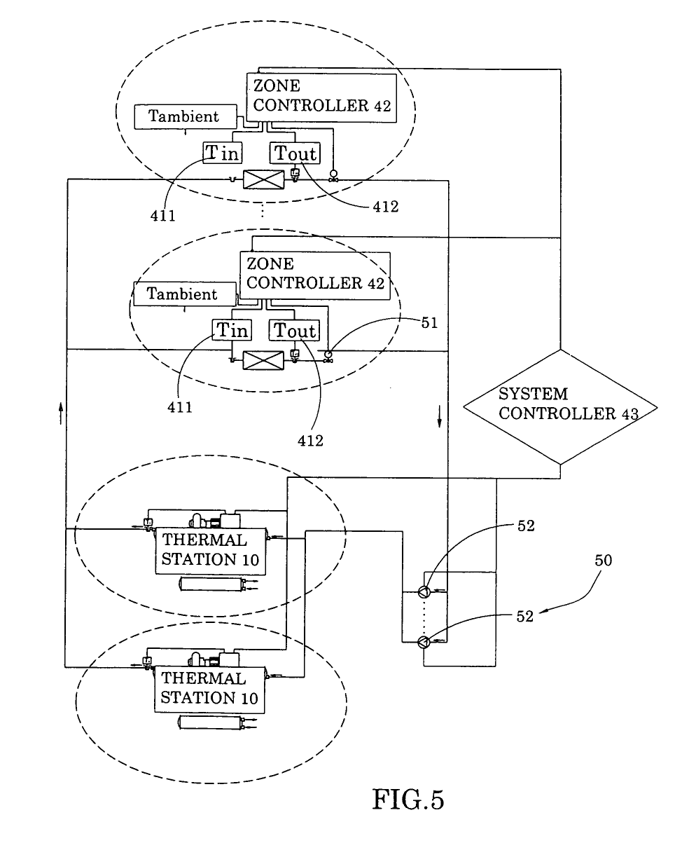

Referring to FIGS. 1 and 5 of the drawings, a climate control system according to a first preferred embodiment is illustrated for incorporating with a building having a plurality of thermal zones, wherein the climate control system comprises at least one thermal station 10, a duct system 20, a plurality of heat exchangers 30, and a delivering device 50.

The thermal station 10 is embodied in the present embodiment to comprise a chiller unit for cooling device and/or a heat pump for heating device.

The delivering device 50 comprises one or more pump units 52 for delivering heat exchange medium from the thermal station 10 to each of the heat exchangers 30 via the duct system 20. According to the first preferred embodiment, the heat exchange medium is embodied to be delivered to circulating between the thermal station 10 and the heat exchangers 30 in the duct system 20. The delivering device 50 further comprises one or more control valves 51 operatively provided at the end loop terminals respectively to regulate the flow rate of the medium.

The duct system 20 comprises a plurality of delivering ducts which defines one or more end loop terminals at each of the thermal zones, wherein medium is delivered to each of the end loop terminals at the thermal zones respectively in a circulating manner. Accordingly, the duct system 20 has an outgoing duct section extending from the thermal station 10 to the thermal zones and a returning duct section extending from the thermal zones back to the thermal station 10.

Accordingly, each of the end loop terminals is defined at the respective thermal zone. Therefore, between the outgoing duct section and the returning duct section of the duct system 20, the medium is pumped to each of the end loop terminals through the outgoing duct section of the duct system 20 and is returned from each end loop terminal back to the thermal station 10 through the returning duct section. In other words, the medium is guided to enter into and exit from the end loop terminal at each of the thermal zones.

The heat exchanger 30, such as a fan coil unit or an air handling unit, is located at each of the thermal zones for generating an air flow to enhance the heat-exchange between the medium and the air within the respective thermal zone. According to the first preferred embodiment, the heat exchanger 30 may comprise a fan unit 31 for generating the air flow and a heat exchanging unit 32, which is located at the respective end loop terminal of the duct system 20 and arranged in such a manner that when the medium is guided to pass through the heat exchanging unit 32, the air flow is guided to blow towards the heat exchanging unit 32 for proceeding the heat exchange process. It is worth mentioning that the air temperature of the incoming air flow is the ambient temperature of the respective thermal zone.

According to the first preferred embodiment of the present invention, the energy saving system for the climate control system, which comprises a temperature sensor device 41 and a zone controller 42, is operatively linked to the thermal station 10, the delivering device 50 and the heat exchangers 30 in order to control the operation of the thermal station 10, the delivering device 50 and the heat exchangers 30 in an energy saving manner.

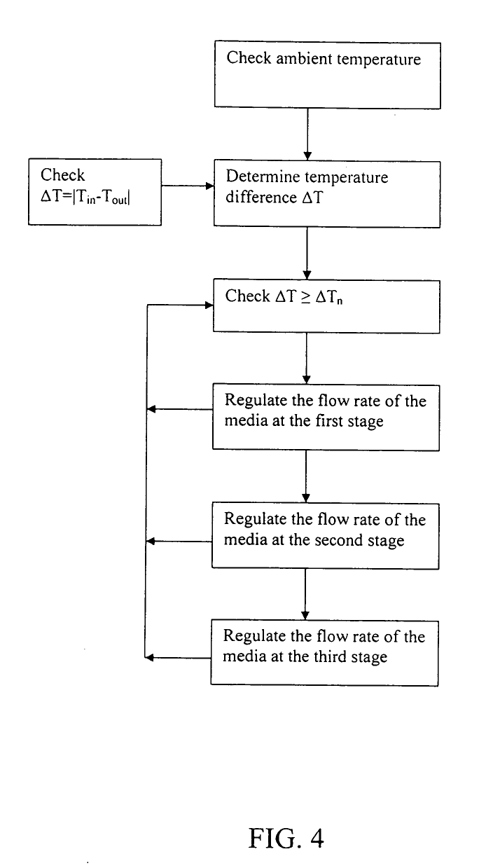

As shown in FIG. 4, by means of the energy saving device, the climate control system can substantially execute an energy saving method comprising the following steps:

(1) Detect the temperature difference AT of the medium at each end loop terminal of the duct system 20 by the temperature sensor device 41 for ensuring efficient heat exchange process occurring at each of the thermal zones.

(2) Adjustably regulate the flow rate of the medium through the control valve in responsive to the temperature difference ΔT at each thermal zone, via the zone controller 42, until the medium is maintained at the optimum flow rate to reach a desired temperature of the respective thermal zone, so as to provide a thermal comfort at the thermal zone while being energy efficient.

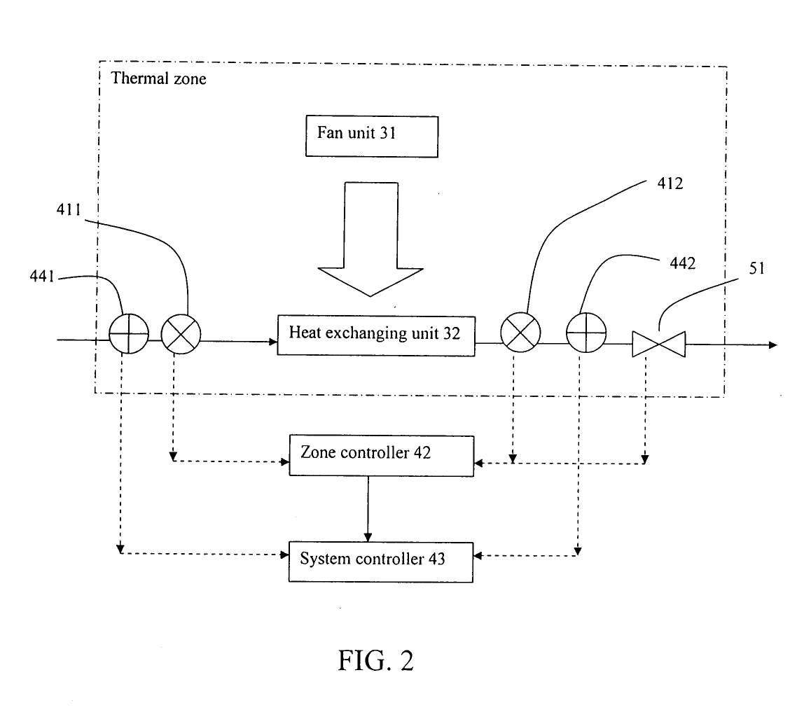

According to the first preferred embodiment, the temperature sensor device 41, which is linked and equipped with the zone controller 42, comprises a temperature inlet sensor 411 and a temperature outlet sensor 412, wherein the temperature inlet sensor 411 and the temperature outlet sensor 412 are arranged to determine the temperature difference ΔT of the medium at each of the end loop terminals of the duct system 20, as shown in FIG. 2.

The temperature inlet sensor 411 is located at an inlet of the end loop terminal at each of the thermal zones for detecting an inlet temperature of the medium. In other words, the temperature inlet sensor 411 is installed at the outgoing duct section of the duct system 20 to directly detect the temperature of the medium before entering into the thermal zone. Particularly, the temperature inlet sensor 411 is positioned at the inlet of the heat exchanging unit 32 of the heat exchanger 30 to detect the temperature of the medium before the heat exchange process.

The temperature outlet sensor 412 is located at an outlet of the respective end loop terminal of the thermal zone for detecting an outlet temperature of the medium. In other words, the temperature outlet sensor 412 is installed at the returning duct section of the duct system 20 to detect the temperature of the medium after exiting out of the thermal zone. Particularly, the temperature outlet sensor 412 is positioned at the outlet of the heat exchanging unit 32 of the heat exchanger 30 to detect the temperature of the medium after the heat exchange process. According to the first preferred embodiment, the temperature difference ΔT is determined between the inlet temperature and the outlet temperature for ensuring efficient heat exchange process occurring at each of the thermal zones.

Practically, ΔT=|Tᵢₙ−Tₒᵤₜ| (1)

In the equation (1), Tᵢₙ is the inlet temperature detected by the temperature inlet sensor 411 and Tₒᵤₜ is the outlet temperature detected by the temperature outlet sensor 412.

According to the first preferred embodiment, the inlet temperature and the outlet temperature can be obtained by two different configurations. The temperature inlet sensor 411 and the temperature outlet sensor 412 are installed within the duct system 20 to directly detect the temperature of the medium before entering into the thermal zone and after exiting out the thermal zone respectively. In other words, when the medium flows within the duct system 20, the temperature inlet sensor 411 and the temperature outlet sensor 412 will directly contact with the flow of the medium to detect the inlet temperature and the outlet temperature respectively.

Alternatively, the temperature inlet sensor 411 and the temperature outlet sensor 412 are installed at the duct system 20 to detect the temperature of the duct system while the medium flowing through at a position before entering into the thermal zone and after exiting out the thermal zone respectively. Particularly, the temperature inlet sensor 411 and the temperature outlet sensor 412 can be installed at the duct surface of the duct system 20 such that when the medium passes through the duct system 20, the temperature inlet sensor 411 and the temperature outlet sensor 412 can detect the duct surface temperature in response to the temperature of the medium.

Accordingly, the temperature sensor device 41 not only ensures heat exchange process occurring at each of the thermal zones but also provides a precise measurement of how much heat exchange is done by the heat exchanger 30 by determining the temperature difference ΔT between the inlet temperature and the outlet temperature.

In addition, once the temperature inlet sensor 411 and the temperature outlet sensor 412 read the inlet temperature and the outlet temperature, the temperature sensor device 41 will send the temperature difference information to the zone controller 42 by wire or wirelessly. Accordingly, the zone controller 42 will control the control valve 51 to adjust the flow rate of the medium at the respective thermal zone with respect to the temperature difference information sent to the zone controller 42.

Accordingly, the signal of the temperature difference information can be sent by wiring the temperature inlet sensor 411 and the temperature outlet sensor 412 to the zone controller 42 or by wirelessly linking the temperature inlet sensor 411 and the temperature outlet sensor 412 with the zone controller 42.

It is worth mentioning that when two or more end loop terminals are used at one thermal zone, one temperature inlet sensor 411 can be used to detect the inlet temperature of the group of the end loop terminals and one temperature outlet sensor 412 can be used to detect the outlet temperature of the group of the end loop terminals. Or, alternatively, two or more temperature outlet sensors 412 can be used to detect the outlet temperature of the medium of the two or more end loop terminals respectively.

Also, when two or more neighboring thermal zones are grouped to form a thermal group, one temperature inlet sensor 411 can be used to detect the inlet temperature of the thermal group while two or more temperature outlet sensors 412 can be used to detect the outlet temperature of the neighboring thermal zone respectively. In other words, the temperature difference ΔT can be determined by the difference between the inlet temperature of the temperature inlet sensor 411 and outlet temperature of each of the temperature outlet sensor 412.

According to the first preferred embodiment, water, especially pure water, can be used as the medium to flow along the duct system 20 by the delivering device 50 of the thermal station 10. As the cooling device, the chiller unit of the thermal station 10 will chill the medium at a predetermined temperature lower than the ambient temperature of the thermal zones and the delivering device 50 will deliver the chilled water to each of end loop terminals at the thermal zones for heat exchange. As the heating device, the heat pump of the thermal station 10 will heat the medium at a predetermined temperature higher than the ambient temperature of the thermal zones and the delivering device 50 will deliver the heated water to the end loop terminals at the thermal zones.

Generally speaking, water has larger specific heat compared with any gas such that the heat exchange is much better than any other gas. On the other hand, water has higher stability such that is much safer for use. Moreover, the demand of the thermal medium is usually huge especially in the building. Water is easy to get in our lives and is also inexpensive. Therefore, water can be a better choose as the medium.

When water is used as the medium, the temperature inlet sensor 411 and the temperature outlet sensor 412 can read the inlet water temperature and the outlet water temperature.

It is appreciated that other medium, such as gas, air or other liquids, can be used as the medium too. Since the temperature difference ΔT can be precisely detected by the temperature inlet sensor 411 and the temperature outlet sensor 412, the temperature inlet sensor 411 and the temperature outlet sensor 412 can also read the inlet temperature and outlet temperature of other thermal medium in order to determined the temperature difference ΔT.

It is worth mentioning that other sensor device can be used as well in responsive to the physical properties of the medium for heat exchange. Accordingly, the temperature of water is changed before and after the heat exchange. Therefore, temperature sensor is preferably used to detect the water temperature when water is used as the medium. However, other physical properties of the medium, such as pressure, can be used as a parameter to measure the energy consumption of the heat exchange. In other words, other thermal medium, which is able to change a physical property in response to heat exchange, can be used as the medium in the climate control system.

According to the first preferred embodiment, each of the zone controllers 42 polls the inlet and outlet temperatures of its respective heat exchanger 30 downstream of the thermal station 10, wherein the zone controller 42 is operatively linked with the control valve 51 to control and actuate the control valves 51. In particularly, each zone controller 42 is operative to configure the degree of opening of the control valve 51 to regulate the medium flow in responsive to the inlet and outlet temperature difference ΔT of the heat exchanger 30 in its respective thermal zone to maintain the medium at the necessary flow rate to provide a thermal comfort at the thermal zone while being energy efficient.

According to the first preferred embodiment, a nominal temperature difference ΔTₙ is preset in the zone controller 42, as a set-point value, to control the temperature difference ΔT not smaller than the nominal temperature difference ΔTₙ in order to adjustably regulate the flow rate of the medium.

ΔT≧ΔTₙ (2)

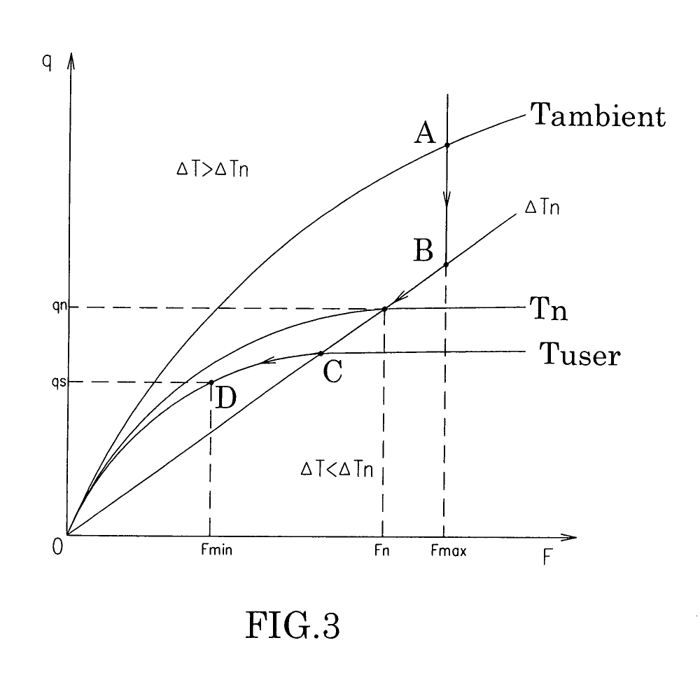

In the above equation (2), the nominal temperature difference ΔTₙ can be preset according to the design of the climate control system. As shown in FIG. 3, the nominal temperature difference ΔTₙ is preset as a non-zero constant that heat exchange is directly proportion to the flow rate of the medium.

E=C*ΔT*F (3)

In the above equation (3), E is the heat exchange quantity (joule/time), C is a constant (joule/(volume*Temperature)), ΔT is the temperature difference (° C. or ° F.), and F is the flow rate (volume/time).

It is worth mentioning that the nominal temperature difference ΔTₙ is set to form a nominal temperature difference line which is a straight line, as shown in FIG. 3, by plugging into ΔTₙ=ΔT. In addition, the nominal temperature difference line further defines two areas in FIG. 3. The efficient area is defined at the area on or above the nominal temperature difference line, wherein the heat exchange process can efficiently proceed in response to higher heat exchange quantity and lower flow rate of medium, i.e., at the efficient area, ΔT≧ΔT_{E}. Another area is the inefficient area defined below the nominal temperature difference line, wherein the heat exchange process inefficiently proceeds in response to lower heat exchange quantity and higher flow rate of medium, i.e. at the inefficient area, ΔT<ΔTₙ.

FIG. 3 further illustrates the heat exchange characteristics curves of heat exchange unit at different ambient temperatures, wherein the uppermost heat exchange characteristics curve shows the characteristics of the ambient temperature, for example 28° C., and the lowermost heat exchange characteristics curve shows the characteristics at the user desired temperature Tᵤₛₑᵣ. It is worth mentioning that for cooling mode, as shown in FIG. 3, the ambient temperature T_{ambient} is greater than the user desired temperature Tᵤₛₑᵣ. For heating mode, the ambient temperature T_{ambient} is smaller than the user desired temperature Tᵤₛₑᵣ.

Each of the heat exchange characteristics curves shows two different phases. The first phase of the heat exchange characteristics curve is that when the flow rate of medium is substantially increased from zero, the heat exchange is dramatically increased. The second phase of the heat exchange characteristics curve is that when the flow rate of medium is kept increasing, the increase of heat exchange is zero or tends to be zero.

According to the first preferred embodiment, the zone controller 42 controls the flow rate of the medium at each end loop terminal at the respective thermal zone in responsive to the nominal temperature difference ΔTₙ from a first stage to a second stage. Accordingly, a maximum flow rate Fₘₐₓ is set when the control valve 51 is fully opened.

At the first stage, the flow rate of the medium is set at its maximum Fₘₐₓ, i.e. the control valve 51 is fully opened, until the temperature difference ΔT reaches the nominal temperature difference ΔTₙ. As shown in FIG. 3, when the maximum flow rate Fₘₐₓ is maintained for a predetermined time period, the heat exchange quantity E will dramatically drop from point A at the higher zone ambient temperature heat exchange characteristics curve to point B at the lower zone ambient temperature heat exchange characteristics curve, wherein at point B, ΔT=ΔTₙ. In other words, at the first stage, the heat exchange quantity E will drop from point A to point B at the maximum flow rate Fₘₐₓ of the medium.

At the second stage, the flow rate of the medium is gradually reduced in condition that the temperature difference ΔT is detected not smaller than the nominal temperature difference ΔTₙ according to the equation (2). Accordingly, the heat exchange quantity E will drop until it reaches the nominal temperature difference line at point C. The heat exchange quantity E will gradually reduce along the nominal temperature difference line until reaching point C wherein the zone ambient temperature reaches the desired temperature Tᵤₛₑᵣ. In other words, points B and C lie on the nominal temperature difference line.

At the second stage, the zone controller 42 controls the flow rate of the medium in a linear manner in response to the nominal temperature difference ΔTₙ. Accordingly, when the value of the temperature difference ΔT is detected equal to or smaller than the nominal temperature difference ΔTₙ, the zone controller 42 will adjustably decrease the flow rate of the medium. When the value of the temperature difference ΔT is detected larger than the nominal temperature difference ΔTₙ, the zone controller 42 will maintain the flow rate of the medium. Depending on the temperature difference ΔT, the zone controller 42 will gradually reduce the flow rate of the medium preferably in a linear manner.

As shown in FIG. 3, the zone controller 42 will reduce the flow rate of the medium in response to the nominal temperature difference ΔTₙ until the desired zone ambient temperature Tᵤₛₑᵣ is reached, i.e. point C. It is worth mentioning that when the flow rate of medium is gradually reduced, the power usage of the delivering device 50 will correspondingly be reduced thus saving energy.

At the third stage, the zone controller 42 further controls the flow rate of the medium in response to the desire zone temperature Tᵤₛₑᵣ that the flow rate of the medium is kept reducing and maintaining the desire zone ambient temperature Tᵤₛₑᵣ at the respective thermal zone. According to the third stage, the flow rate of the medium is reduced from point C to point D along the heat exchange characteristics curve in response to the desired ambient temperature Tᵤₛₑᵣ. Accordingly, the zone controller 42 will control the flow rate of the medium at its minimum flow rate Fₘᵢₙ such that point D is the minimum flow rate Fₘᵢₙ of the medium. In other words, by using the system of the present invention, the flow rate of medium at each thermal zone can be efficiently controlled between the minimum flow rate Fₘᵢₙ and the maximum flow rate Fₘₐₓ.

It is worth mentioning that when the flow rate of the medium is reduced at the third stage, the ambient temperature of the thermal zone is remained at the desired temperature Tᵤₛₑᵣ for providing a thermal comfort at the thermal zone according to the desired temperature heat exchange characteristics curve.

It is worth mentioning that at the third stage, the temperature difference ΔT is greater than the nominal temperature difference ΔTₙ. Therefore, the main focus of the zone controller is to monitor the ambient temperature to ensure the zone ambient temperature staying at the desired ambient temperature Tᵤₛₑᵣ while gradually reducing the flow rate of the medium until the flow rate can no longer be reduced, i.e. the point D.

Accordingly, when the ambient temperature increases, i.e. above the desired zone temperature Tᵤₛₑᵣ, the zone controller 42 will controllably increase the flow rate of the medium from point D towards the point C along the desired temperature heat exchange characteristics curve. When the zone ambient temperature keeps increasing, zone controller 42 will controllably increase the flow rate of the medium from point C towards the point B along the nominal temperature difference line. In other words, the flow path from point A, point B, point C, to point D is reversible that the zone controller 42 can efficiently regulate the flow rate of the medium. It is worth mentioning that the path from point A, point B, point C, to point D is set within the efficient area.

The present invention is able to particularly save the energy consumption of the circulating delivering device 50 by controlling the flow rate of the medium. In other words, when the flow rate of the medium is reduced, the delivering device 50 requires less energy to pump the medium to the thermal zone through the duct system 20. The following is to illustrate how to determine the thermal transporting efficiency of the delivering device 50.

ER=E/P (4)

In equation (4), ER is the thermal transporting efficient rate of the delivering device 50, E is the medium heat exchange quantity (joule/time), and P is the power consumption of the circulating delivering device 50 (joule/time).

In addition, the power consumption of the circulating delivering device 50 is that:

P=F*g*H/η (5)

In equation (5), F is the flow rate of the medium, g is the gravity, H is the elevation distance of the medium being delivered from the delivering device 50 (water-head), and η is the efficiency of the delivering device 50.

By combining the equations (3), (4), and (5), the thermal transporting efficiency of the delivering device 50 is that:

ER=(C*ΔT*F)/(F*g*H/η)=(C*ΔT*η)/(g*H)

For water as the medium, C is 4.18, therefore:

ER=427*ΔT*η/H (6)

When ΔT=ΔTₙ, ERₙ=427*ΔTₙ*η/H

According to the equation (2), when ΔT≧ΔTₙ, then:

ER≧ERₙ

In other words, the thermal transporting efficiency of the delivering device 50 (ER) at any operating condition is equal to or larger than the nominal transporting efficiency of the delivering device 50 (ERₙ) at the nominal temperature difference ΔTₙ, i.e. ΔT≧ΔTₙ. Therefore, the delivering device 50 also works within the efficient area according to the first preferred embodiment.

As mentioned above, energy saving can be achieved by providing the zone controller 42 at each thermal zone with control logic to operatively configure the degree of opening of the control valve 51 to regulate the medium flow in response to the inlet and outlet temperature difference of the heat exchanger 30 in its respective thermal zone to maintain medium at the minimum flow rate to provide a thermal comfort at the thermal zone while reducing the energy consumption of the delivering device 50.

It is worth mentioning that when the degree of opening of the control valve 51 is reduced, the flow of medium through the duct system 20 will be correspondingly reduced. Then, the water-head (evaluation distance) H of the delivering device 50 will be increased. As a result, the pressure difference ΔP at the most adverse end loop terminal will be increased. Therefore, the system controller 43 will regulate the pressure difference ΔP at the most adverse end loop terminal until the pressure difference ΔP at the most adverse end loop terminal reaches the nominal pressure difference ΔPₙ. Specifically, the system controller 43 will decrease the speed of the delivering device 50 in response to the pressure different ΔP between both ends of the heat exchanger 30 located in the most adverse end loop terminal downstream of the thermal station 10 to ensure that ΔP=ΔPₙ. As the speed of delivering device 50 is reduced, further energy saving is achieved because the delivering device 50 with lower speed will require less energy to operate.

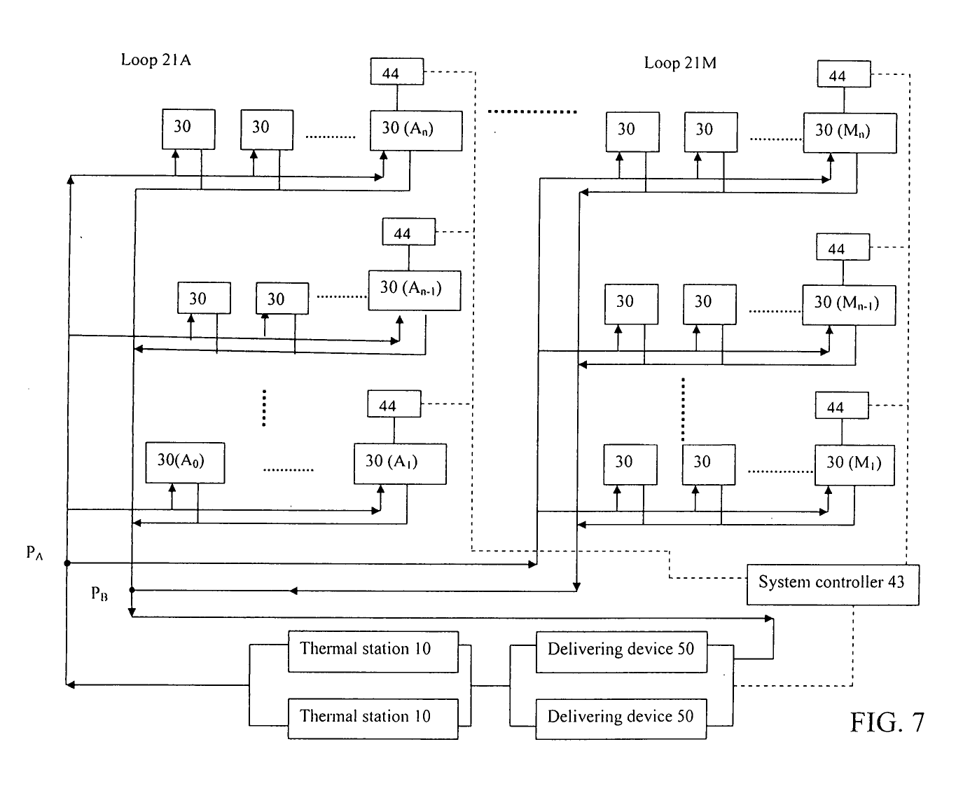

According to the first preferred embodiment, the energy saving system 40 further comprises a pressure sensor device 44 at each of the selected thermal zones, as shown in FIG. 2 and FIG. 7. The pressure sensor device 44 is arranged for detecting a pressure difference ΔP of medium between inlet and outlet of the heat exchanger 30 at the respective thermal zone. Accordingly, the pressure sensor device 44 ensures the pressure difference ΔP between both ends of the heat exchanger 30 located in the most adverse end loop terminal to remain constant by lowering or increasing the speed of the delivering device 50 so as to minimize the energy use of the delivering device 50 while providing a thermal comfort at the thermal zone.

According to the first preferred embodiment, the pressure sensor device 44, which is linked to the system controller 43 comprises a pressure inlet sensor 441 and a pressure outlet sensor 442, wherein the pressure inlet sensor 441 and the pressure outlet sensor 442 are adapted to determine the pressure difference ΔP of the medium at the potential most adverse end loop terminals of the duct system 20, as shown in FIGS. 2 and 7.

The pressure inlet sensor 441 is located at an inlet of the end loop terminal at each of the thermal zones for detecting an inlet pressure of the medium. Particularly, the pressure inlet sensor 441 is located at the inlet of the heat exchanging unit 32 of the heat exchanger 30 to detect the pressure of the medium before the heat exchange process.

The pressure outlet sensor 442 is located at an outlet of the respective end loop terminal of the thermal zone for detecting an outlet pressure of the medium. Particularly, the pressure outlet sensor 442 is located at the outlet of the heat exchanging unit 32 of the heat exchanger 30 to detect the pressure of the medium after the heat exchange process. According to the first preferred embodiment, the pressure difference ΔP is determined between the inlet pressure and the outlet pressure of the medium.

Particularly, each of the pressure sensor devices 44 is arranged for detecting the pressure difference between both ends of the heat exchanger 30 located in each potential most adverse end loop terminal downstream of the thermal station 10, wherein by polling the detected pressure differences of the potential most adverse end loop terminals, the pressure difference in every moment between both ends of the heat exchanger 30 in the most adverse end loop terminal downstream of the thermal station 10 can be determined and be maintained to a preset value, that is ΔP=ΔPₙ, wherein ΔPₙ is nominal pressure difference.

According to the first preferred embodiment, as shown in FIG. 7, depending on the actual arrangement or layout of the environment, the duct system 20 may extend to have more than one heat exchanging loops 21, each grouping a plurality of the heat exchangers 30, wherein one of the grouped heat exchangers 30 of each the heat exchanging loop 21 is predetermined as the potential most adverse end loop terminal thereof and the respective pressure sensor device 44 is located at each the potential most adverse end loop terminal to detect the pressure difference thereof. It is worth mentioning that which heat exchanger 30 within each of the heat exchanging loops 21 should be designated as the potential adverse end loop terminal could be determined by the experienced designer of the climate control system, for example the most distal heat exchanger 30 of each heating exchanging loop 21 would be the one having the least pressure of that heating exchanging loop 21.

As shown in FIG. 7, the pressure sensor device 44 is located at each the potential most adverse end loop terminal to detect the pressure difference thereof, wherein under different operating conditions, the potential most adverse end loop terminal will be changed correspondingly. For example, the duct system 20 may have a plurality of heat exchanging loops 21A to 21M, wherein the medium is arranged to flow to all heat exchanging loops 21A to 21M that all control valves 51 thereof are fully opened. The system controller 43 will determine the pressure differences ΔP_{A1} . . . ΔP_{An} . . . , ΔP_{M1} . . . ΔP_{Mn} of the potential most adverse end loop terminals of the heat exchanging loops 21A to 21M. Then, the system controller 43 will determine the most adverse end loop terminal with the least value of ΔP, such that the ΔPₘᵢₙ is the pressure difference of the most adverse end loop terminal. For example, if ΔP_{An} is the ΔPₘᵢₙ, the heat exchanger 30(Aₙ) at the heat exchanging loop 21A will be designated as the most adverse end loop terminal.

Another example illustrates that when the control valve 51 at the heat exchanging loop 21A is closed, the potential most adverse end loop terminal will be located at the heat exchanging loop 21M. According to the heat exchanging loop 21A, the pressure differences of all the end loop terminals at the heat exchanging loop 21A at point P_{A} and P_{B} are the same, i.e. ΔP_{A-B}, wherein ΔP_{A-B} is larger than the pressure difference at all the end loop terminals at the heat exchanging loop 21M. When ΔP_{Mn} is the ΔPₘᵢₙ, the heat exchanger 30(Mₙ) at the heat exchanging loop 21M will be designated as the most adverse end loop terminal.

Another example illustrates that when the control valve 51 at the heat exchanging loop 21M is closed, the potential most adverse end loop terminal will be located at the heat exchanging loop 21A. When ΔP_{An} is the ΔPₘᵢₙ, the heat exchanger 30(Aₙ) at the heat exchanging loop 21A will be designated as the most adverse end loop terminal.

Therefore, under different operating conditions, the potential most adverse end loop terminal will be altered correspondingly. When the pressure sensor device 44 is located at each the potential most adverse end loop terminal to detect the pressure difference thereof, the system controller 43 can poll the pressure difference ΔP between both ends of the heat exchangers located in each the potential most adverse end loop terminal downstream of the thermal station 10 every moment so as to determine which potential most adverse end loop terminal is the most adverse end loop terminal. When ΔPₘᵢₙ is found within the pressure differences ΔP of all heat exchangers 30, the system controller 43 will regulate the delivering device 50 through the frequency converter until ΔP=ΔPₙ.

Another example illustrates that when only one control valve 51 at the heat exchangers 30A₀ of the first level of the end loop terminal of the heat exchanging loop 21A is opened while the rest of the control valves 51 at the end loop terminal of the heat exchanging loop 21A are off, the pressure sensor device 44 at the heat exchanger 30A₁ will obtain the pressure differences ΔP thereat which is the same as the pressure differences ΔP at the heat exchanger 30A₁. Therefore, the system controller will regulate the delivering device 50 until ΔP_{A0}=ΔPₙ.

The system controller 43 polls the pressure difference ΔP between both ends of the heat exchangers located in each the potential most adverse end loop terminal downstream of the thermal station 10 every moment so as to determine which potential most adverse end loop terminal is the most adverse end loop terminal wherein its pressure difference is the smallest among the pressure differences of all of the potential most adverse end loop terminals at each moment.

Accordingly, the system controller 43 is operatively linking with the pressure sensor devices 44 located in the potential most adverse end loop terminals for adjustably regulating the speed of delivering device 50 in response to the pressure difference until the pressure difference ΔP in the most adverse end loop terminal is maintained at the preset value ΔPₙ so as to provide a thermal comfort at the thermal zone while being energy efficient.

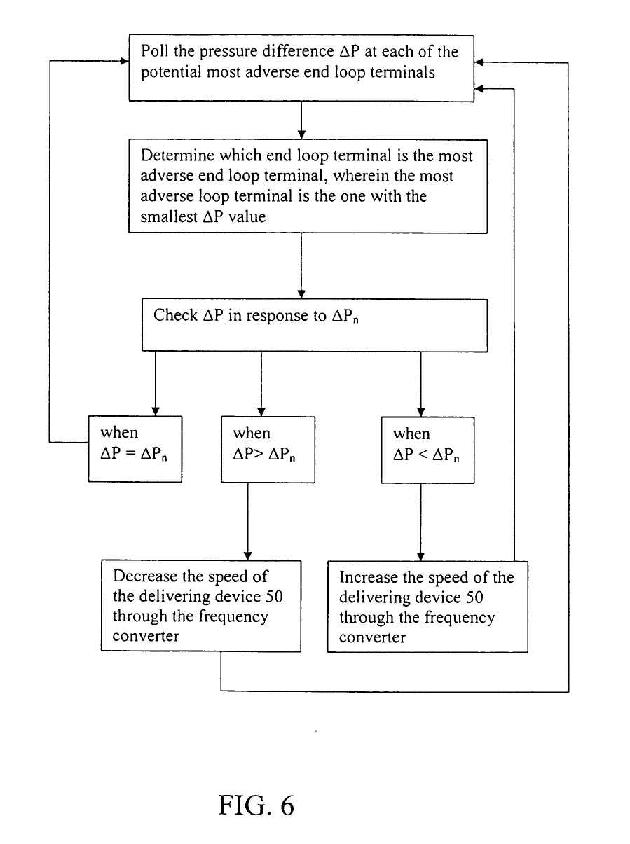

As shown in FIG. 6, if the pressure difference ΔP is increased, the system controller 43 will decrease the speed of the delivering device 50 through the frequency converter to decrease the pressure difference ΔP until the pressure difference ΔP reaches predetermined value which is the nominal pressure difference ΔPₙ. If the pressure difference ΔP is decrease, the system controller 43 will increase the speed of the delivering device 50 through the frequency converter to increase the pressure difference ΔP until the pressure difference reaches the nominal pressure difference ΔPₙ.

As shown in FIGS. 1 and 5, the system controller 43 polls the degree of opening of all control valves 51 from the zone controllers 42 associated with a series of heat exchangers 30 downstream of the thermal station 10. In particular, the system controller 43 is operative to send command to the thermal station control system to regulate the outlet medium temperature of the thermal station 10 in response to the degree of opening of control valves 51 to ensure the thermal station 10 consuming the least amount energy to provide the conditioned (heated or cooled) medium to each thermal zone to meet the thermal comfort need at the thermal zones. Accordingly, the system controller 43 will regulate the medium at the highest possible temperature outputting from the thermal station 10 in a cooling mode such that the thermal station 10 will save energy to chill the medium for delivering to each thermal zone. Likewise, the system controller 43 will regulate the medium at the lowest possible temperature outputting from the thermal station 10 in a heating mode such that the thermal station 10 will save energy to heat the medium for delivering to each thermal zone.

In other words, the system controller 43 will send command to the thermal station 10 to regulate the outlet water temperature of the thermal station in response to the degree of opening of control valves to ensure that: (1) in cooling mode, the climate control system can meet the thermal comfort need at the thermal zones with medium with the highest possible temperature; (2) in heating mode, the climate control system can meet the thermal comfort need at the thermal zones with medium with the lowest possible temperature so as to reduce the energy use of the thermal station 10.

If the greatest degree of opening of the selected control valves 51, which are the control values located at the thermal zones where the zone ambient temperature has reached the user desired temperature Tᵤₛₑᵣ steadily, is sensed to be smaller than a preset value of very close to 100%, the system controller 43 is operative to send command to the thermal station 10 to: (1) in cooling mode, increase the outlet temperature of the thermal station until the greatest degree of opening of selected control valves 51 reach the preset value; (2) in heat mode, decrease the outlet temperature of the thermal station 10 until the greatest degree of opening of selected control valves 51 reach the preset value.

Therefore, the system controller 43 of the present invention will (1) polls the pressure difference ΔP between both ends of the heat exchanger located in each the potential most adverse end loop terminal downstream of the thermal station, and/or (2) poll the degree of opening of all control valves 51 from zone controllers associated with a series of heat exchangers 30 downstream of the thermal station 10.

Accordingly, the energy saving method for the climate control system further comprises the following step.

(3) Detect the pressure difference between both ends of the heat exchanger located in each the potential most adverse end loop terminal for ensuring adequate pressure for the duct system 20.

The energy saving method for the climate control system according to the first preferred embodiment may further comprise the following step.

(4) Detect the degree of opening of all control valves 51 for ensuring heat station 10 consuming the least possible energy to condition (cool or heat) medium while providing thermal comfort at each thermal zone.

According to the first preferred embodiment, the zone controller 42 further operatively controls the heat exchanger 30 to adjustably regulate an air flow thereof in response to the difference between zone ambient temperature and desired ambient zone temperature Tᵤₛₑᵣ, i.e. zone ambient temperature—desired zone ambient temperature Tᵤₛₑᵣ=ΔT_{ambient}. Accordingly, the zone controller 42 operatively controls the operation of the fan unit 31 to regulate the air flow towards the heat exchanging unit 32. When the air flow rate of the fan unit 31 is increased, the heat exchange process at the heat exchanging unit 32 is correspondingly speeded up. Likewise, when the air flow rate of the fan unit 31 is reduced, the heat exchange process at the heat exchanging unit 32 is correspondingly slowed down.

Preferably, the fan unit 31 is set to provide three different rate settings, i.e. high rate, medium rate, and low rate. When ΔT_{ambient} is equal to or greater than a preset value V1, the high rate of fan unit 31 is selected to enhance the heat exchange process such that the ambient temperature will dramatically drop. When ΔT_{ambient} is equal to or greater than a preset value V2 but smaller than V1, the medium of fan unit 31 is selected. When ΔT_{ambient} is smaller than a preset value V2, the low rate of fan unit 31 is selected.

It is worth mentioning that the preferred embodiments of the present invention not adopts the energy saving mode through the circulating delivering device 50 efficiency improvement, but better utilize controlling the temperature difference at the heat exchange end. In other words, the first preferred embodiment of the present invention is not aimed at improving the equipment efficiency, but aim at improving the thermal transporting efficiency of the climate control system. Therefore, every circulation of the thermal medium is capable of take advantage of good heat exchange efficiency thus saving energy of the delivering device 50.

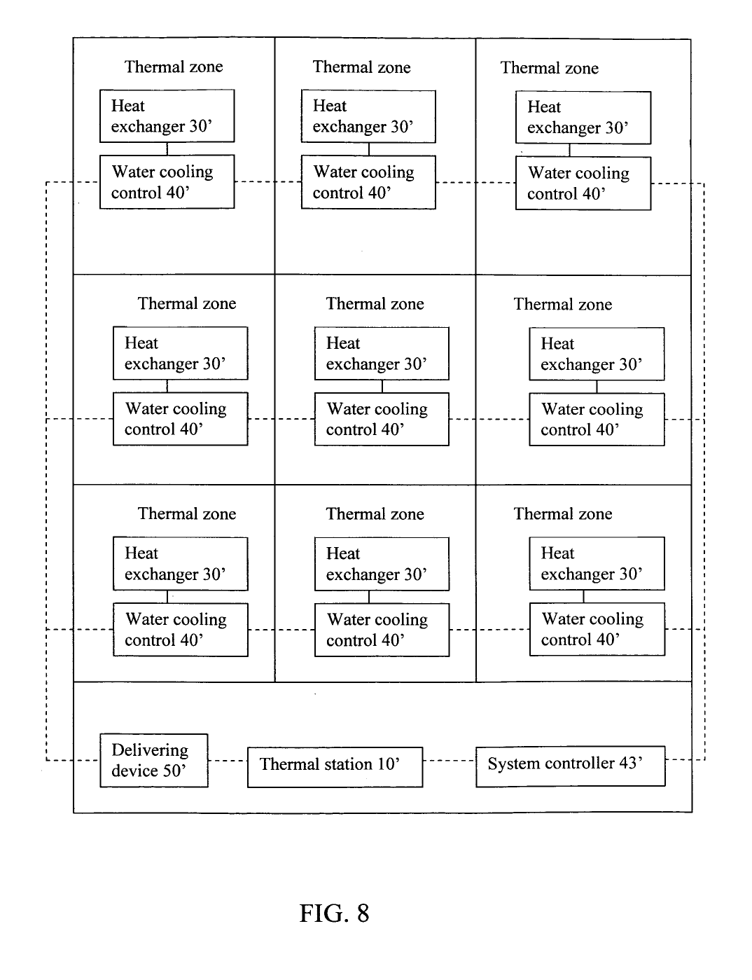

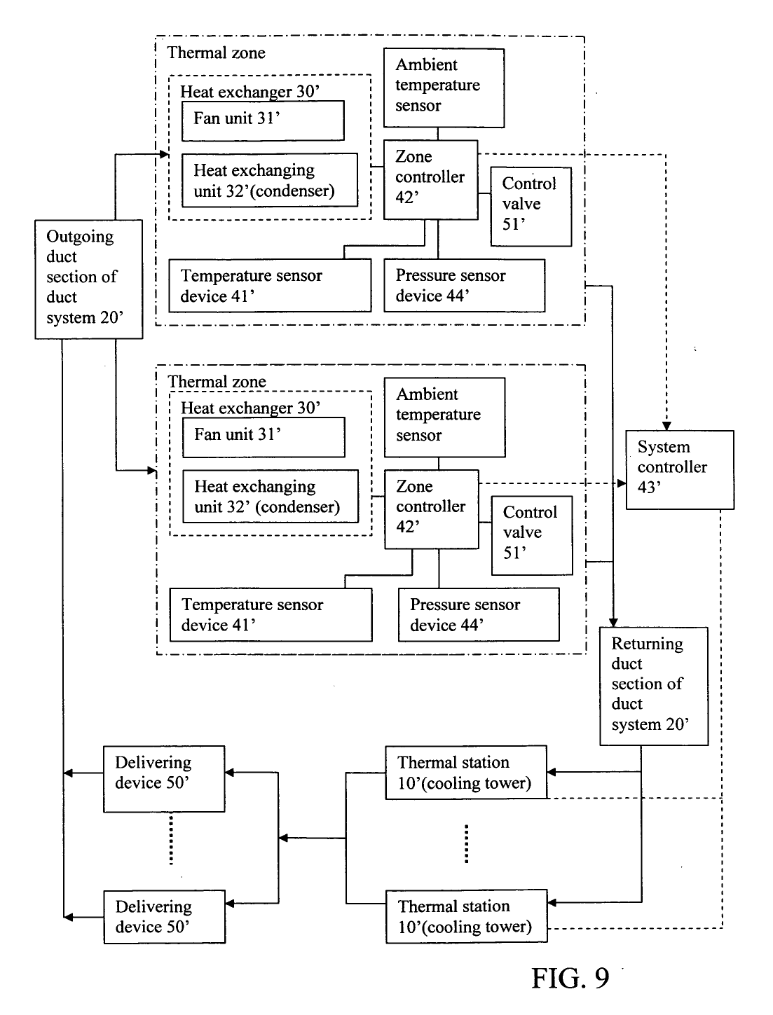

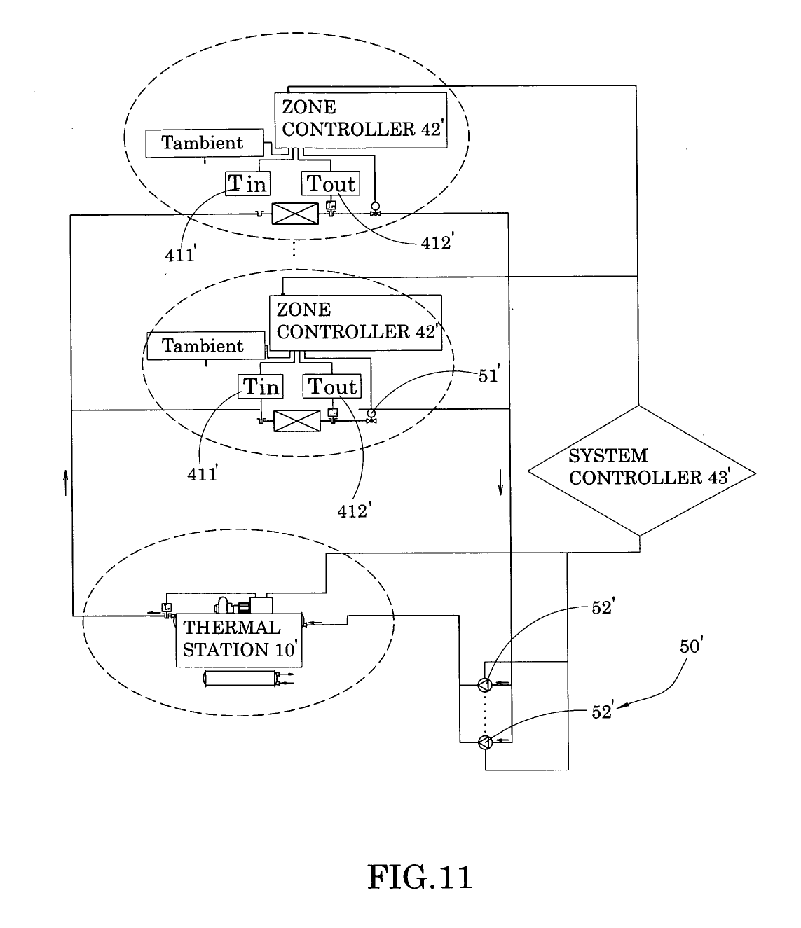

Referring to FIGS. 8 to 12 of the drawings, a water cooling system of a building structure for an air conditioning system of a second preferred embodiment illustrates an alternative mode of the first embodiment of the present invention. The water cooling system is for incorporating into at least two thermal zones located in a building structure or in a plurality of building structure. For example, the water cooling system may be used in an apartment building divided into a plurality of apartment units that the thermal zone is defined at each apartment unit. On the other hand, the water cooling system may be used in an estate type community area divided into a plurality of building structure in which one or more thermal zones are defined.

According to the second embodiment, a plurality of heat exchangers 30′, such as air conditioner units, are installed at the thermal zones respectively. The heat exchanger 30′ is located at each of the thermal zones for generating an air flow to enhance the heat-exchange between the medium and the air within the respective thermal zone. Residents in each of the thermal zones can select their own heat exchanger 30′ according to the size of the thermal zone. In other words, different types or different powers of the heat exchangers 30′ can be selectively provided at the thermal zones respectively. Generally speaking, the heat exchanger 30′ comprises a fan unit 31′ for generating the air flow and a heat exchanging unit 32′ arranged in such a manner that when the medium is guided to pass through the heat exchanging unit 32′, the air flow is guided to blow towards the heat exchanging unit 32′ for proceeding the heat exchange process. It is worth mentioning that the air temperature of the incoming air flow is the ambient temperature of the respective thermal zone.

Accordingly, each of the heat exchangers 30′ is embodied as an air conditioning unit to cool the ambient air of the thermal zone for thermal comfort. The heat exchanging unit 32′ comprises a compressor, an expansion valve and a cooler/evaporator for generating cool air into the thermal zone. The condenser can be located within the thermal zone or out of the thermal zone. It is worth mentioning that the condenser of the heat exchanger 30′ is arranged to dissipate heat of the internal cooling agent of the heat exchanger 30′ when the internal cooling agent is guided to flow between the evaporator and the condenser in a cycling manner.

Preferably, the condenser is a water cooling type condenser that the heat from the condenser is removed by water flow. During operation, the fan unit 31′ generates the air flow towards the cooler/evaporator for generating a cooling air to the thermal zone while heat is generated at the condenser for heat exchange. The condenser may or may not locate at the thermal zone and the heat will be guided to a designated location via the water cooling system of the present invention. During the heat exchange process of the heat exchanger 30′, cool air is guided to enter into the respective thermal zone, wherein heat is generated and must be dissipated out from the respective thermal zone. The conventional air conditioning unit is an air cooling type heat exchanger that the heat from the air conditioning system is released outside the building and is dissipated by the surroundings of the building. It is worth mentioning that the heat exchanger 30′ is operated at its optimized condition when the heat generated from the heat exchanger 30′ can be efficiently removed.

The water cooling system according to a second preferred embodiment of the present invention comprises at least one thermal station 10′, a duct system 20′, a temperature sensor device 41′, and a delivering device 50′ for operatively connecting to the heat exchangers 30′. The water cooling system further comprises a water cooling control 40′ which comprises a temperature sensor device 41′ and a zone controller 42′ is operatively linked to the thermal station 10′ and the delivering device 50′.

The thermal station 10′ is embodied to comprise a chiller unit for cooling device and/or a heat pump for heating device. According to the second embodiment, the thermal station 10′ is embodied to comprises a cooling tower for providing cooling water as the heat transmitter to each of the heat exchangers 30′ to maintain the optimum efficiency of each of the heat exchangers 30′. However, under some environmental condition in which a natural source of hot or cooled medium is conveniently available, such as the cool underground water in Beijing, China, the chiller unit and/or the heat pump become an optional configuration.

The delivering device 50′ comprises one or more pump units 52′ for delivering a medium through the duct system 20′ from the thermal station 10′ to each of the heat exchanger 30′ and that the heat exchange medium is circulated between the thermal station 10′ and the heat exchangers 30′. According to the second embodiment, the medium is a cooling medium, such as water, to carry the heat out of the heat exchangers 30′. In particular, the water is pumped from the thermal station 10′ to the condenser of each of the heat exchangers 30′ to cool down the condenser thereof and is guided to return back to the thermal station 10′ via the delivering device 50′. In other words, cooling water is pumped to the condenser and the hot water is guided to return back to the thermal station 10′.

The duct system 20′ comprises a plurality of delivering ducts which defines one or more end loop terminals at each of the thermal zones, wherein the medium is delivered to each of the end loop terminals at the thermal zones respectively and is returned from each of the end loop terminals at the thermal zones respectively. That is to say, the medium, such as water, is circulated between the thermal station 10′ and each of the heat exchangers 30′ (i.e. the condenser) respectively via the duct system 20′. The duct system 20′ has an outgoing duct section extending from the thermal station 10′ to the thermal zones and a returning duct section extending from the thermal zones back to the thermal station 10′.

According to the second embodiment, the duct system 20′ can be pre-installed into the building, wherein the outgoing duct section and the returning duct section of the duct system 20′ are pre-configured to each of the thermal zones. In other words, the connection ends of the outgoing duct section and the returning duct section are pre-set at each of the thermal zones such that when the desired heat exchanger 30′ is installed at the respective thermal zone, the desired heat exchanger 30′ can be directly connected to the duct system 20′ by connecting the connection ends of the outgoing duct section and the returning duct section to the heat exchanger 30′ to form the respective end loop terminal so as to guide the medium flowing from the thermal station 10′ to the respective heat exchanger 30′ through the duct system 20′.

The delivering device 50′ further comprises one or more control valves 51′ operatively provided at the end loop terminals respectively to regulate the flow rate of the medium. Between the outgoing duct section and the returning duct section of the duct system 20′, the medium is pumped to each of the end loop terminals through the outgoing duct section of the duct system 20′ and is returned from each end loop terminal back to the thermal station 10′ through the returning duct section. In other words, the medium is guided to enter into and exit from the end loop terminal at each of the thermal zones.

The water cooling system according to the second preferred embodiment of the present invention employs an energy saving method, comprising the steps of:

(1) Detect the temperature difference ΔT of the medium at each end loop terminal of the duct system 20′ by the temperature sensor device 41′ for ensuring efficient heat exchange process of the respective heat exchanger 30′ occurring at each of the thermal zones.

(2) Adjustably regulate the flow rate of the medium through the control valve 51′ in responsive to the temperature difference ΔT at each thermal zone, via the zone controller 42′, until the medium is maintained at the optimum flow rate to effectively cool down the respective heat exchanger 30′ while being energy efficient.

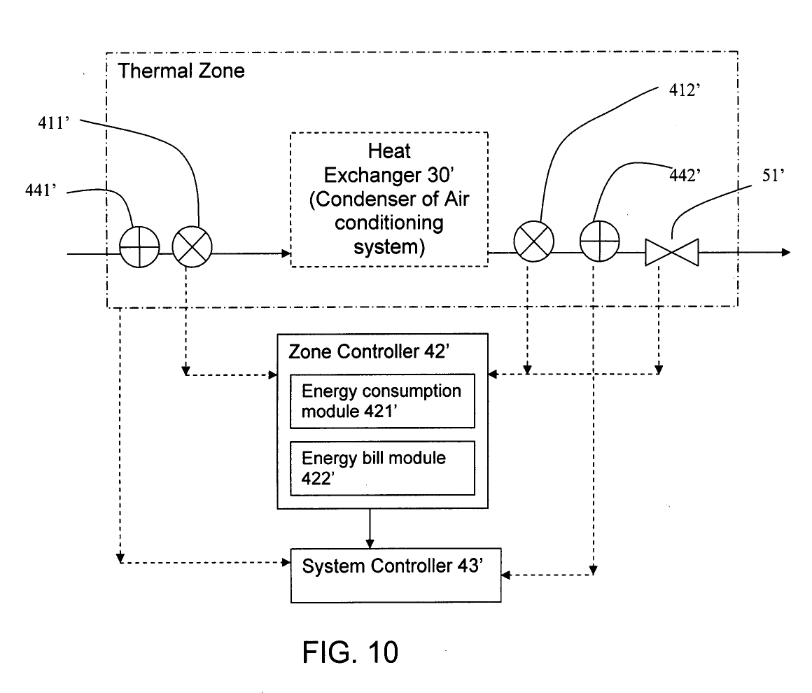

According to a second preferred embodiment of the present invention, the temperature sensor device 41′, which is linked and equipped with the zone controller 42′, comprises a temperature inlet sensor 411′ and a temperature outlet sensor 412′, wherein the temperature inlet sensor 411′ and the temperature outlet sensor 412′ are arranged to determine the temperature difference ΔT of the medium at each of the end loop terminals of the duct system 20′, as shown in FIG. 10. In other words, the temperature sensor device 41′ determines the temperature difference ΔT of the medium before cooling down the condenser and after cooling down the condenser.

The temperature inlet sensor 411′ is located at an inlet of the end loop terminal at each of the thermal zones for detecting an inlet temperature of the medium, i.e. the water temperature before cooling down the condenser. In other words, the temperature inlet sensor 411′ is installed at the outgoing duct section of the duct system 20′ to directly detect the temperature of the medium before entering into the thermal zone and before removing the heat from the respective heat exchanger 30′. Particularly, the temperature inlet sensor 411′ is positioned at an inlet of the heat exchanger 30′ to detect the temperature of the medium before the heat exchange process.

The temperature outlet sensor 412′ is located at an outlet of the respective end loop terminal of the thermal zone for detecting an outlet temperature of the medium i.e. the water temperature after cooling down the condenser. In other words, the temperature outlet sensor 412′ is installed at the returning duct section of the duct system 20′ to detect the temperature of the medium after exiting out of the thermal zone. Particularly, the temperature outlet sensor 412′ is positioned at the outlet of the heat exchanger 30′ to detect the temperature of the medium after the heat exchange process to remove the heat from the respective heat exchanger 30′. The temperature difference ΔT is determined between the inlet temperature and the outlet temperature for ensuring efficient heat exchange process occurring at each of the thermal zones and is represented by the above mentioned equation (1)

ΔT=|Tᵢₙ−Tₒᵤₜ| (1)

In equation (1), Tᵢₙ is the inlet temperature, i.e. the inlet water temperature, detected by the temperature inlet sensor 411′ and Tₒᵤₜ is the outlet temperature, i.e. the outlet water temperature, detected by the temperature outlet sensor 412′. Accordingly, when the cooling water enters into the respective heat exchanger 30′ to cool down thereof, the heat from the heat exchanger 30′ will be dissipated such that warm water will be exited from the respective heat exchanger 30′. Therefore, the temperature difference ΔT is determined by the amount heat being dissipated from the heat exchanger 30′.

The temperature inlet sensor 411′ and the temperature outlet sensor 412′ have two preferred configurations respectively. First, the temperature inlet sensor 411′ and the temperature outlet sensor 412′ are installed within the duct system 20′ to directly detect the temperature of the medium before entering into the thermal zone and after exiting out the thermal zone respectively. In other words, when the medium flows within the duct system 20′, the temperature inlet sensor 411′ and the temperature outlet sensor 412′ will directly contact with the flow of the medium to detect the inlet temperature and the outlet temperature respectively. Second, the temperature inlet sensor 411′ and the temperature outlet sensor 412′ are installed at the duct system 20′ to detect the temperature of the duct system while the medium flowing through at a position before entering into the thermal zone and after exiting out the thermal zone respectively. Particularly, the temperature inlet sensor 411′ and the temperature outlet sensor 412′ can be installed at the duct surface of the duct system 20′ such that when the medium passes through the duct system 20′, the temperature inlet sensor 411′ and the temperature outlet sensor 412′ can detect the duct surface temperature in response to the temperature of the medium. Accordingly, the temperature sensor device 41′ provides a precise measurement of the quantity of heat change by determining the temperature difference ΔT between the inlet temperature and the outlet temperature.

In addition, once the temperature inlet sensor 411′ and the temperature outlet sensor 412′ read the inlet temperature and the outlet temperature, the temperature sensor device 41′ will send the temperature difference information to the zone controller 42′ through wired or wireless communication. Accordingly, the zone controller 42′ will control the control valve 51′ to adjust the flow rate of the medium at the respective thermal zone with respect to the temperature difference information sent to the zone controller 42′. In other words, the flow rate of the medium will be substantially increased when more heat is generated by the respective heat exchanger 30′ needed to cool down.

It is worth mentioning that when two or more end loop terminals are used at one thermal zone, one temperature inlet sensor 411′ can be used to detect the inlet temperature of the group of the end loop terminals and two or more temperature outlet sensors 412′ can be used to detect the outlet temperature of the medium of the two or more end loop terminals respectively.

Also, when two or more neighboring thermal zones are grouped to form a thermal group, one temperature inlet sensor 411′ can be used to detect the inlet temperature of the thermal group while two or more temperature outlet sensors 412′ can be used to detect the outlet temperature of the neighboring thermal zone respectively. In other words, the temperature difference ΔT can be determined by the difference between the inlet temperature of the temperature inlet sensor 411′ and outlet temperature of each of the temperature outlet sensor 412′.

Since the temperature difference ΔT is the preferred determining factor of the equation (1) as applied, the medium can be any form of liquids or gases such as water and air as long as the temperature difference ΔT can be determined. According to the second preferred embodiment of the present invention, the medium is preferred to be water, especially when the environmental condition provides a convenience source of water.

It is worth mentioning that the temperature sensor device 41′, the temperature inlet sensor 411′ and the temperature outlet sensor 412′ may be substituted by other type of sensors or sensor devices corresponding to the use of another physical property of the medium such as pressure or density to determine the changes before and after the heat exchange.

According to a second preferred embodiment, each zone controller 42′ polls the inlet temperature of the medium and the outlet temperature of the medium, and is operatively linked with the control valve 51′ to control and actuate the control valves 51′. Each zone controller 42′ is operative to configure the degree of opening of the control valve 51′ to regulate the medium flow in responsive to temperature difference in each respective thermal zone to maintain the medium at the necessary flow rate to provide a thermal comfort at the thermal zone while being energy efficient.

According to the preferred embodiment, the flow rate of the medium is controlled by the adjustment of the control valve 51′ with respect to the temperature difference ΔT. In other words, the flow rate of the medium is regulated efficiently by the opening of the control valves 51′.

In particularly, the nominal temperature difference ΔTₙ is preset in the zone controller 42′, as a set-point value, to control the temperature difference ΔT equal to the nominal temperature difference ΔTₙ, i.e. ΔT=ΔTₙ, in order to adjustably regulate the flow rate of the medium. Accordingly, the nominal temperature difference ΔTₙ can be preset according to the design of the water cooling system. The nominal temperature difference ΔTₙ is preset as a non-zero constant that heat removed from the respective heat exchanger 30′ is directly proportion to the flow rate of the medium. In other words, when the temperature difference ΔT is larger than the nominal temperature difference ΔTₙ, the control valve 51′ will be regulated for increasing the flow rate of the medium to remove the heat. When the temperature difference ΔT is smaller than the nominal temperature difference ΔTₙ, the control valve 51′ will be regulated for decreasing the flow rate of the medium.

Accordingly, the control valve 51′ is controllably regulated between a fully opened condition and a closed condition. At the fully opened condition, the flow rate of the medium is set at its maximum Fₘₐₓ. When the temperature difference ΔT is larger than the nominal temperature difference ΔTₙ, the control valve 51′ can be set at the fully opened to ensure the temperature difference ΔT rapidly reaching the nominal temperature difference ΔTₙ to remove the heat in a short period of time. When the maximum flow rate Fₘₐₓ is maintained for a predetermined time period to remove the heat from the respective heat exchanger 30′, the heat exchange quantity E will dramatically drop from at a point that ΔT is close to ΔTₙ.

When the temperature difference ΔT closes to the nominal temperature difference ΔT_{E}, the flow rate of the medium is gradually reduced. The flow rate of the medium is set at its minimum in condition that the temperature difference ΔT is detected equal to the nominal temperature difference ΔTₙ.

The zone controller 42′ controls the flow rate of the medium in response to the nominal temperature difference ΔTₙ. Accordingly, when the value of the temperature difference ΔT is detected smaller than the nominal temperature difference ΔTₙ, the zone controller 42′ will adjustably decrease the flow rate of the medium. When the value of the temperature difference ΔT is detected larger than the nominal temperature difference ΔTₙ, the zone controller 42′ will adjustably increase the flow rate of the medium. Depending on the temperature difference ΔT, the zone controller 42′ will gradually reduce the flow rate of the medium preferably in a linear manner.

In addition, the zone controller 42′ further controls the flow rate of the medium in response to the heat dissipation of the heat exchanger 30′ that the flow rate of the medium is kept reducing while the heat removed from the respective heat exchanger 30′ at the respective thermal zone is reduced. The heat being efficiently removed from the heat exchanger 30′ is the most efficient operation of the heat exchanger 30′ to maintain the desired temperature Tᵤₛₑᵣ for providing a thermal comfort at the thermal zone.

Accordingly, when more heat is generated by the heat exchanger 30′, the zone controller 42′ will controllably increase the flow rate of the medium. When the amount of heat from the heat exchanger 30′ keeps increasing, the zone controller 42′ will controllably increase the flow rate of the medium to cool down the heat exchanger 30′.

In other words, the zone controller 42′ can efficiently regulate the flow rate of the medium to efficiently cool down the heat exchanger 30′.

The present invention is able to particularly save the energy consumption of the circulating delivering device 50′ by controlling the flow rate of the medium to efficiently cool down the heat exchangers 30′. In other words, when the flow rate of the medium is reduced, the delivering device 50′ requires less energy to pump the medium to the thermal zone through the duct system 20.

It is worth mentioning that when the degree of opening of the control valve 51′ is reduced, the flow of medium through the duct system 20′ will be correspondingly reduced. Then, the water-head (evaluation distance) H of the delivering device 50′ will be increased. As a result, the pressure difference ΔP at the most adverse end loop terminal will be increased. Therefore, the system controller 43′ will regulate the pressure difference ΔP at the most adverse end loop terminal until the pressure difference ΔP at the most adverse end loop terminal reaches the nominal pressure difference ΔPₙ. Specifically, the system controller 43′ will decrease the speed of the delivering device 50′ in response to the pressure different ΔP between both ends of the heat exchanger 30′ located in the most adverse end loop terminal downstream of the thermal station 10′ to ensure that ΔP=ΔPₙ. As the speed of delivering device 50′ is reduced, further energy saving is achieved because the delivering device 50′ with lower speed will require less energy to operate.

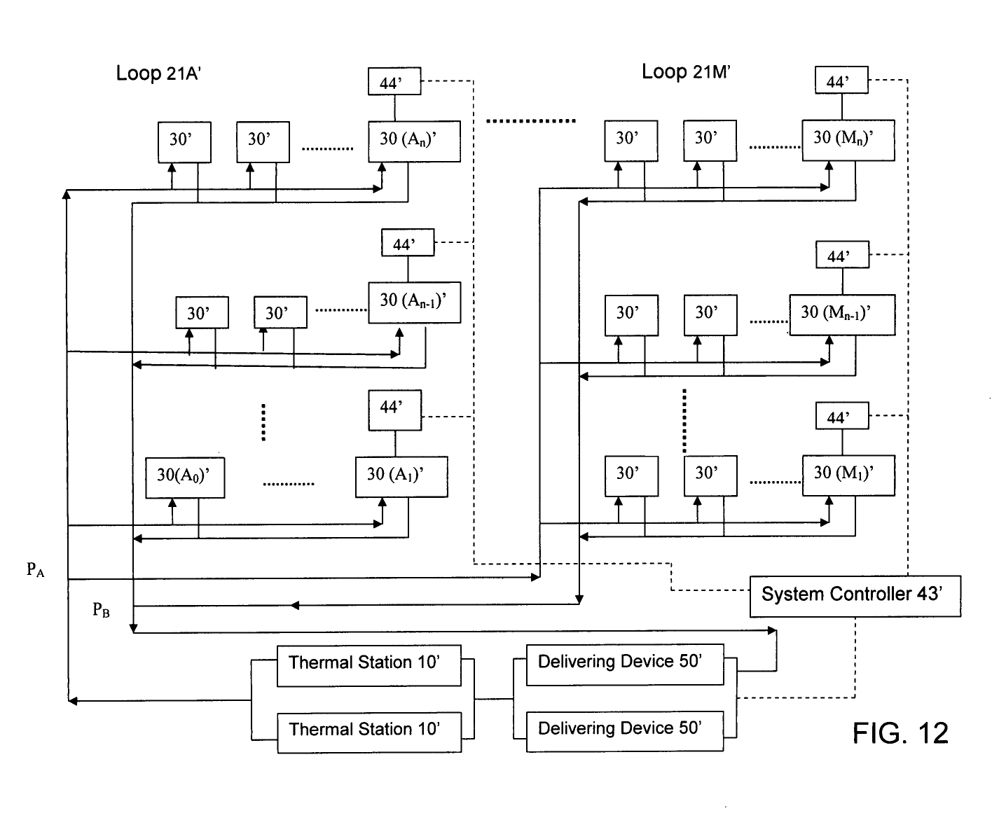

According to the second preferred embodiment, the water cooling control 40′ further comprises a pressure sensor device 44′ as the differential pressure sensors in the potential most adverse end loop terminals, as shown in FIGS. 10 and 12. The pressure sensor device 44′ is arranged for detecting a pressure difference ΔP of medium between inlet and outlet of the heat exchanger 30′ at the respective thermal zone, which is corresponding to the outgoing duct section and the returning duct section of the duct system 20′ respectively. Accordingly, the pressure sensor device 44′ ensures the pressure difference ΔP between both ends of the heat exchanger 30′ located in the most adverse end loop terminal to remain constant by lowering or increasing the speed of the delivering device 50′ so as to minimize the energy use of the delivering device 50′. The pressure sensor device 44′, which is linked to the system controller 43 comprises a pressure inlet sensor 441′ and a pressure outlet sensor 442′, wherein the pressure inlet sensor 441′ and the pressure outlet sensor 442′ are adapted to determine the pressure difference ΔP of the medium at the potential most adverse end loop terminals of the duct system 20′.

The pressure inlet sensor 441′ is located at an inlet of the end loop terminal at each of the thermal zones for detecting an inlet pressure of the medium. Particularly, the pressure inlet sensor 441′ is located at the inlet of the heat exchanger 30′ which is corresponding to the outgoing duct section of the duct system to detect the pressure of the medium before the heat exchange process.

The pressure outlet sensor 442′ is located at an outlet of the respective end loop terminal of the thermal zone for detecting an outlet pressure of the medium. Particularly, the pressure outlet sensor 442′ is located at the outlet of the heat exchanger 30 which is corresponding to the returning duct section of the duct system 20′ to detect the pressure of the medium after the heat exchange process. According to the second preferred embodiment, the pressure difference ΔP′ is determined between the inlet pressure and the outlet pressure of the medium.

Particularly, each of the pressure sensor devices 44′ is arranged for detecting the pressure difference between both ends of the heat exchanger 30′ located in each potential most adverse end loop terminal downstream of the thermal station 10′, wherein by polling the detected pressure differences of the potential most adverse end loop terminals, the pressure difference in every moment between both ends of the heat exchanger 30′ in the most adverse end loop terminal downstream of the thermal station 10′ can be determined and be maintained to a preset value, that is ΔP=ΔPₙ, wherein ΔPₙ is nominal pressure difference.

As shown in FIG. 12, the pressure sensor device 44′ is located at each the potential most adverse end loop terminal to detect the pressure difference thereof, wherein under different operating conditions, the potential most adverse end loop terminal will be changed correspondingly. For example, the duct system 20′ may have a plurality of heat exchanging loops 21A′ to 21M′, wherein the medium is arranged to flow to all heat exchanging loops 21A′ to 21M′ that all control valves 51′ thereof are fully opened. The system controller 43′ will determine the pressure differences ΔP_{A1} . . . ΔP_{An} . . . , ΔP_{M1} . . . ΔP_{Mn} of the potential most adverse end loop terminals of the heat exchanging loops 21A′ to 21M′. Then, the system controller 43′ will determine the most adverse end loop terminal with the least value of ΔP, such that the ΔPₘᵢₙ is the pressure difference of the most adverse end loop terminal. For example, if ΔP_{An} is the ΔPₘᵢₙ, the heat exchanger 30(Aₙ)′ at the heat exchanging loop 21A′ will be designated as the most adverse end loop terminal.

Another example illustrates that when the control valve 51′ at the heat exchanging loop 21A′ is closed, the potential most adverse end loop terminal will be located at the heat exchanging loop 21M′. According to the heat exchanging loop 21A′, the pressure differences of all the end loop terminals at the heat exchanging loop 21A′ at point P_{A} and P_{B} are the same, i.e. ΔP_{A-B}, wherein ΔP_{A-B} is larger than the pressure difference at all the end loop terminals at the heat exchanging loop 21M′. When ΔP_{Mn} is the ΔPₘᵢₙ, the heat exchanger 30(Mₙ)′ at the heat exchanging loop 21M′ will be designated as the most adverse end loop terminal.

Another example illustrates that when the control valve 51′ at the heat exchanging loop 21M′ is closed, the potential most adverse end loop terminal will be located at the heat exchanging loop 21A′. When ΔP_{An} is the ΔPₘᵢₙ, the heat exchanger 30′(Aₙ) at the heat exchanging loop 21A′ will be designated as the most adverse end loop terminal.

Therefore, under different operating conditions, the potential most adverse end loop terminal will be altered correspondingly. When the pressure sensor device 44′ is located at each the potential most adverse end loop terminal to detect the pressure difference thereof, the system controller 43′ can poll the pressure difference ΔP between both ends of the heat exchangers located in each the potential most adverse end loop terminal downstream of the thermal station 10′ every moment so as to determine which potential most adverse end loop terminal is the most adverse end loop terminal. When ΔPₘᵢₙ is found within the pressure differences ΔP of all heat exchangers 30′, the system controller 43′ will regulate the delivering device 50′ through the frequency converter until ΔP=ΔPₙ.

Another example illustrates that when only one control valve 51′ at the heat exchangers 30A₀′ of the first level of the end loop terminal of the heat exchanging loop 21A′ is opened while the rest of the control valves 51′ at the end loop terminal of the heat exchanging loop 21A′ are off, the pressure sensor device 44′ at the heat exchanger 30A₁′ will obtain the pressure differences ΔP thereat which is the same as the pressure differences ΔP at the heat exchanger 30A₁′. Therefore, the system controller will regulate the delivering device 50′ until ΔP_{A0}=ΔPₙ.

The system controller 43′ polls the pressure difference ΔP between both ends of the heat exchangers located in each the potential most adverse end loop terminal downstream of the thermal station 10′ every moment so as to determine which potential most adverse end loop terminal is the most adverse end loop terminal wherein its pressure difference is the smallest among the pressure differences of all of the potential most adverse end loop terminals at each moment.

Accordingly, the system controller 43′ is operatively linking with the pressure sensor devices 44′ located in the potential most adverse end loop terminals for adjustably regulating the speed of delivering device 50′ in response to the pressure difference until the pressure difference ΔP in the most adverse end loop terminal is maintained at the preset value ΔPₙ so as to ensure the optimum cooling effect at the heat exchanger 30′ while being energy efficient.

According to the embodiment, the heat generated from all the heat exchangers 30′ can be collected by guiding the medium flowing back to the thermal station 10′ from the thermal zones through the returning duct section of the duct system 20′. Therefore, the cooling tower of the thermal station 10′ can cool down the medium before the medium is delivered to each of the thermal zones to cool down the respective heat exchanger 30′ again. Since the heat exchangers 30′ are cooled by the flow of medium, the condenser of the heat exchanger 30′ at each thermal zone does not required being located out of the building structure as the conventional air conditioning system.

In other words, the heat exchangers 30′ can be located within the building structure to enhance the aesthetic appearance of the building structure. In addition, once the heat from all the heat exchangers 30′ is collected in a centralized manner, the water cooling system of the present invention can selectively guide the heat to be dissipated at a desired location. For example, the heat collected by the water cooling system can be guided to dissipate at a good air ventilation area outside the building or at a less population density outside the building. Therefore, the water cooling system also is an environmental friendly system not only enhancing the energy-efficiency of the heat exchangers 30′ but also inflicting minimal on the environment by the heat exchangers 30′.

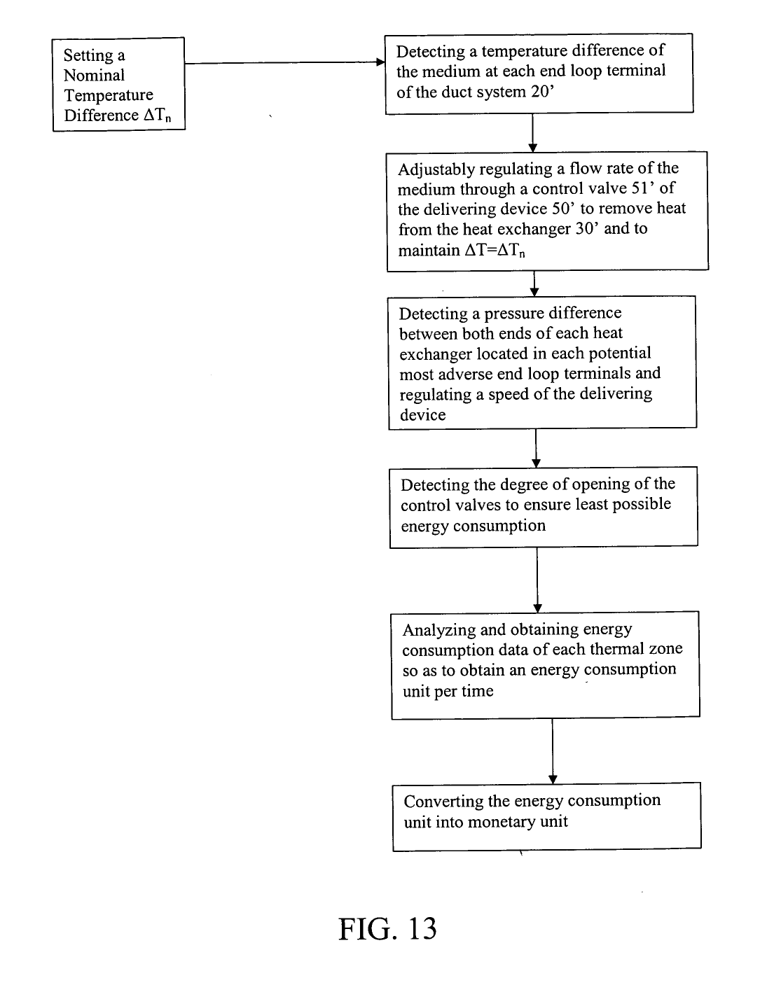

Referring to FIG. 13 of the drawings, the zone controller 42′ further comprises an energy consumption module 421′ for analyzing and obtaining a set of energy consumption data of each thermal zone such that a quantity of energy consumption unit of each thermal zone during a period of time is obtained. As it is mentioned above, the heat generated from the respective heat exchanger 30′ is removed by the medium flowing therethrough. Therefore, the energy consumption data of each of the heat exchangers 30′ can be obtained by the temperature difference ΔT and the flow rate of the medium. In other words, the energy consumption to remove the heat of the heat exchanger 30′ is the energy consumption to guide the flow of the medium thereto.

The zone controller 42′ further comprises an energy bill module 422′ which converts the quantity of energy consumption unit into a monetary unit based on the total energy consumption in monetary unit such that the energy bill for each thermal zone in monetary can be obtained. Accordingly, the total energy consumption in monetary unit can be shared by the residents of the thermal zones proportionally in responsive to the energy consumption data of each of the heat exchangers 30′.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A water cooling control for a building structure which comprises a thermal station, a delivering device for delivering water as a heat transmitter, a duct system circulating the water to one or more end loop terminals at one or more thermal zones respectively, and a heat exchanger located at each of the thermal zones that heat generated therefrom is removed by circulating the water through the duct system, wherein said water cooling control comprises:
a temperature sensor device detecting a temperature difference of the water at each of the end loop terminals of the duct system for determining the amount of heat removed from the respective heat exchanger in responsive to heat exchange of the water; and
a zone controller operatively linking with said temperature sensor device for adjustably regulating a flow rate of the water through a control valve of the delivering device in responsive to said temperature difference at each thermal zone until the water is maintained at the optimum flow rate to ensure the respective heat exchanger being operated at an optimum condition while being energy efficient.

2. The water cooling control, as recited in claim 1, wherein a nominal temperature difference is preset in said zone controller to control said temperature difference equal to said nominal temperature difference in order to adjustably regulate the flow rate of the water.

3. The water cooling control, as recited in claim 2, wherein said nominal temperature difference is preset as a non-zero constant that heat removed from the respective heat exchanger is proportionate to the flow rate of the water.

4. The water cooling control, as recited in claim 1, wherein said temperature sensor device comprises a temperature inlet sensor locating at an inlet of the end loop terminal at each of the thermal zones for detecting an inlet temperature of the water and a temperature outlet sensor locating at an outlet of the respective end loop terminal for detecting an outlet temperature of the water, so as to determine said temperature difference between said inlet temperature and said outlet temperature.

5. The water cooling control, as recited in claim 3, wherein said temperature sensor device comprises a temperature inlet sensor locating at an inlet of the end loop terminal at each of the thermal zones for detecting an inlet temperature of the water and a temperature outlet sensor locating at an outlet of the respective end loop terminal for detecting an outlet temperature of the water, so as to determine said temperature difference between said inlet temperature and said outlet temperature.

6. The water cooling control, as recited in claim 1, wherein said zone controller further comprises an energy consumption module obtaining an energy consumption data of each thermal zone in responsive to an energy consumption to remove the heat of the respective heat exchanger.

7. The water cooling control, as recited in claim 3, wherein said zone controller further comprises an energy consumption module obtaining an energy consumption data of each thermal zone in responsive to an energy consumption to remove the heat of the respective heat exchanger.

8. The water cooling control, as recited in claim 5, wherein said zone controller further comprises an energy consumption module obtaining an energy consumption data of each thermal zone in responsive to an energy consumption to remove the heat of the respective heat exchanger.

9. A water cooling method for a heat exchanger in a building structure which comprises a thermal station having a delivering device, a duct system circulating water as a heat transmitter to the heat exchanger located at each thermal zone of the building structure, wherein the method comprises the steps of:
(a) detecting a temperature difference of the water at each end loop terminal of the duct system for determining the amount of heat removed from the respective heat exchanger in responsive to heat exchange of the water; and
(b) adjustably regulating a flow rate of the water through a control valve of the delivering device in responsive to said temperature difference at each thermal zone until the water is maintained at the optimum flow rate to ensure the respective heat exchanger being operated at an optimum condition while being energy efficient.

10. The method, as recited in claim 9, further comprising a pre-step of presetting a nominal temperature difference to control said temperature difference equal to said nominal temperature difference when adjustably regulating the flow rate of the water.

11. The method, as recited in claim 10, wherein said nominal temperature difference is preset as a non-zero constant that heat removed from the respective air conditioning system is directly proportionate to the flow rate of the water.

12. The method, as recited in claim 9 wherein the step (a) further comprises the steps of:
(a.1) detecting an inlet temperature of the water before the water enters into the respective thermal zone through the duct system;
(a.2) detecting an outlet temperature of the water after the water removes the heat from the respective heat exchanger and exits out the respective thermal zone through the duct system; and
(a.3) determining said temperature difference between said inlet temperature and said outlet temperature of the water.

13. The method, as recited in claim 11, wherein the step (a) further comprises the steps of:
(a.1) detecting an inlet temperature of the water before the water enters into the respective thermal zone through the duct system;
(a.2) detecting an outlet temperature of the water after the water removes the heat from the respective heat exchanger and exits out the respective thermal zone through the duct system; and
(a.3) determining said temperature difference between said inlet temperature and said outlet temperature of the water.

14. The method, as recited in claim 9, further comprising a step of obtaining an energy consumption data of each thermal zone in responsive to an energy consumption to remove the heat of the respective heat exchanger.

15. The method, as recited in claim 13, further comprising a step of obtaining an energy consumption data of each thermal zone in responsive to an energy consumption to remove the heat of the respective heat exchanger.

16. A system for controllably cooling multiple heat exchangers at multiple thermal zones of a building structure, comprising:
a thermal station;
a delivering device, comprising a control valve, for delivering a water flow as a heat transmitter;
a duct system circulating the water to each end loop terminal at each thermal zone for removing heat from the heat exchanger; and
a water cooling control, comprising:
a temperature sensor device detecting a temperature difference of the water at each of the end loop terminals of the duct system for determining the amount of heat removed from the respective heat exchanger in responsive to heat exchange of the water; and
a zone controller operatively linking with said temperature sensor device, wherein a nominal temperature difference is preset in said zone controller to control said temperature difference equal to said nominal temperature difference while adjustably regulating a flow rate of the water through said control valve of said delivering device in responsive to said temperature difference at each thermal zone until the water is maintained at the optimum flow rate for ensuring the respective heat exchanger being operated at an optimum condition while being energy efficient.

17. The system, as recited in claim 16, wherein said nominal temperature difference is preset as a non-zero constant that heat removed from the respective air conditioning system is directly proportionate to the flow rate of the water.

18. The water cooling system, as recited in claim 16, wherein said temperature sensor device comprises a temperature inlet sensor locating at an inlet of the end loop terminal at each of the thermal zones for detecting an inlet temperature of the water and a temperature outlet sensor locating at an outlet of the respective end loop terminal for detecting an outlet temperature of the water, so as to determine said temperature difference between said inlet temperature and said outlet temperature.

19. The water cooling system, as recited in claim 17, wherein said temperature sensor device comprises a temperature inlet sensor locating at an inlet of the end loop terminal at each of the thermal zones for detecting an inlet temperature of the water and a temperature outlet sensor locating at an outlet of the respective end loop terminal for detecting an outlet temperature of the water, so as to determine said temperature difference between said inlet temperature and said outlet temperature.

20. The water cooling system, as recited in claim 16, wherein said zone controller further comprises an energy consumption module obtaining an energy consumption data of each thermal zone in responsive to an energy consumption to remove the heat of the respective heat exchanger.

21. The water cooling system, as recited in claim 19, wherein said zone controller further comprises an energy consumption module obtaining an energy consumption data of each thermal zone in responsive to an energy consumption to remove the heat of the respective heat exchanger.
